(19) United States
(12) Patent Application Publication
(10) Pub. No.: US 2026/0342751 A1
(43) Pub. Date: Oct. 29, 2026

(54) INDICATING DISAGREEMENTS BETWEEN AGENTIC AGENTS

(71) Applicant: Dell Products L.P., Round Rock, TX (US)

(72) Inventors: OFIR EZRIELEV, Be'er Sheva (IL); YEHIEL ZOHAR, Sderot (IL); HANNA YEHUDA, Acton, MA (US)

(21) Appl. No.: 19/192,687

(22) Filed: Apr. 29, 2025

(51) Int. Cl. H04L 51/02; H04L 51/04

(52) U.S. Cl. CPC H04L 51/02; H04L 51/04

(57) ABSTRACT

Methods and systems for managing operation of infrastructure are provided. To manage the infrastructure, agentic agents may be deployed. The deployed agentic agents may be customized prior to deployment and interact with users of the infrastructure via a conversation or other type of interface to attempt to infer intents of the users with respect to computer implemented services provided by the infrastructure. Disagreements in responses of the agentic agents may be identified. Information regarding the disagreements (e.g., a level of disagreement, supplemental information, etc.) may be provided to the users to contextualize the responses from the agentic agents. The contextualized responses may be used to obtain feedback from the user for inferring an intent of the user for management of the infrastructure.

### FIELD

Embodiments disclosed herein relate generally to infrastructure. More particularly, embodiments disclosed herein relate to systems and methods to manage infrastructure using agentic agents.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-1F show data flow diagrams illustrating processing and use of data in accordance with an embodiment.

FIG. 2A shows a diagram illustrating an example of a user interface in accordance with an embodiment.

FIG. 2B shows a data flow diagram illustrating processing and use of data in displaying a disagreement in a conversation in accordance with an embodiment.

FIGS. 3A-3B shows flow diagrams illustrating methods in accordance with an embodiment.

FIG. 4 shows a block diagram illustrating a data processing system in accordance with an embodiment.

### DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of infrastructure. To manage the infrastructure, agentic agents may be deployed and tasked with managing the infrastructure to effectuate the desired intents of users of the infrastructure.

The agentic agents may be customized for different domains. Once customized, users may initiate communications with the agentic agents using a chat interface. The chat interface may be used to convey the intents to the agentic agents. Different agentic agents may be customized to different domains and, therefore, may have access to different types of information, reasoning processes, etc. Accordingly, the agentic agents may generate different responses to chats by the users.

The chat interface may be used to obtain information regarding intents of the user, confirm the intents of the users, and/or align future management activities of the agentic agents with the user intents.

To improve a likelihood that the different responses may be used to obtain the information regarding an intent of the user, disagreements in the different responses between the agentic agents may be identified and indicated to the client. To do so, a facilitator (e.g., an agentic agent tasked to moderate the conversation) may identify the disagreement and a level of the disagreement. Information regarding the disagreement may be provided to the client via the chat interface. Using the information, user feedback may be obtained to refine an understanding of the intent of the user.

By doing so, embodiments disclosed herein may improve the likelihood of services provided by infrastructure being deemed to be desirable by the users. Thus, embodiments discussed herein may address, among others, the technical problem of intent and expectation mismatch between users of infrastructure and the managers of the infrastructure.

In an embodiment, a method for managing infrastructure that provides desired computer implemented services is provided. The method may include (i) obtaining, using a chat interface, a conversation between a client and agentic agents, the agentic agents being adapted to manage the infrastructure on behalf of the client; (ii) identifying at least one disagreement between agentic agents in the conversation; (iii) providing, to the client, information regarding the at least one disagreement to contextualize at least one response in the conversation that is from one of the agentic agents; (iv) obtaining a new chat message for the conversation from the client, the new chat message being based on the contextualized at least one response in the conversation; (v) using the new chat message to infer an intent of the client for management of the infrastructure; and (vi) using, by the agentic agents, the inferred intent to update operation of the infrastructure to facilitate continued provisioning of the desired computer implemented services.

The at least one disagreement may be regarding a topic of the conversation for which the agentic agents have different viewpoints.

Identifying the at least one disagreement may include: (i) prompting at least one large language model of a facilitator to identify the at least one disagreement using at least a portion of the conversation, the at least a portion of the conversation comprising different responses of the agentic agents; and (ii) identifying a level of disagreement for the at least one disagreement.

Identifying the level of disagreement may include: (i) for each response of a plurality of responses that are involved in the at least one disagreement: (a) prompting, by the facilitator, a portion of the agentic agents that have disagreeing responses to a topic of the conversation to obtain acceptability results; and (ii) using the acceptability results to identify the level of disagreement.

Prompting the portion of the agentic agents may include prompting, by the facilitator, each agentic agent of the portion of the agentic agents using a first response of the plurality of responses to provide a new response regarding whether the first response is acceptable with respect to a topic of the conversation.

Providing the information regarding the at least one disagreement may include: (i) making a determination regarding whether the level of disagreement meets a threshold; and (ii) in an instance of the determination where the level of disagreement meets the threshold: (a) displaying the information using the chat interface.

Providing the information regarding the at least one disagreement may include providing a disagreement indicator using the chat interface that indicates that the at least one disagreement is present in the conversation.

The method may also include obtaining user input from the client indicating a request to view the information regarding the at least one disagreement, the user input comprising selecting a button of the disagreement indicator.

The contextualized at least one response may include a unified response that is based on portions of the conversation upon which at least a portion of the agentic agents agree.

The agentic agents may be customized versions of trained agents, each version of the customized versions being trained using a different data set.

The agentic agents may be trained for different domains using different data sets, a viewpoint of an agentic agent of the agentic agents being based on a domain of the different domains for which the agentic agent is trained.

In an embodiment, a non-transitory media is provided that may include instructions that when executed by a processor cause any of the above noted method to be performed.

In an embodiment, a system is provided that may include the non-transitory media and a processor, and may perform any of the above noted method when the computer-instructions are executed by the processor.

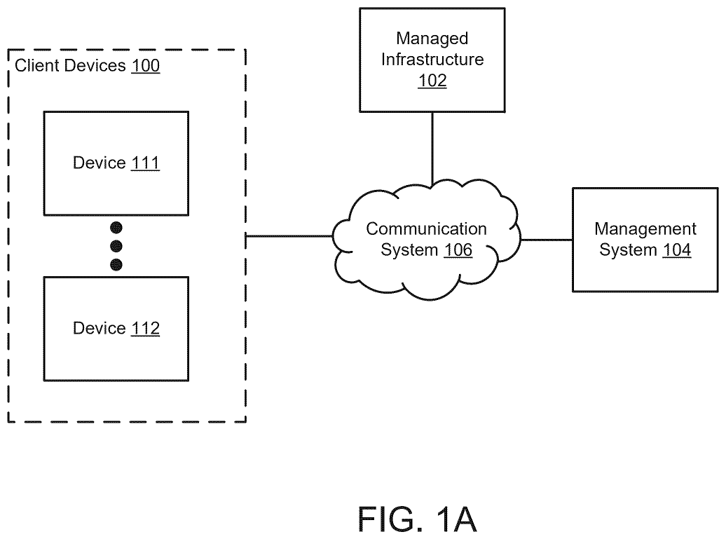

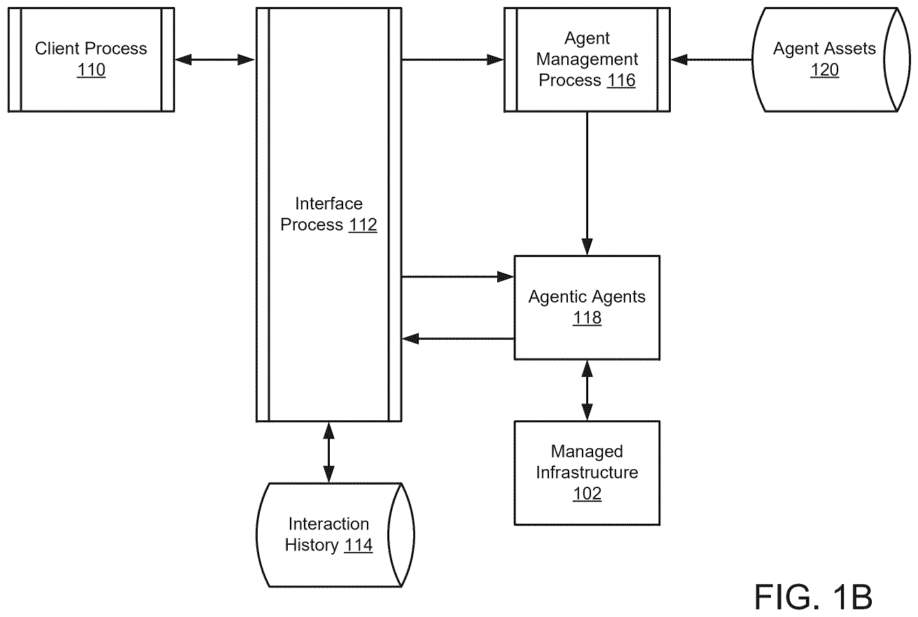

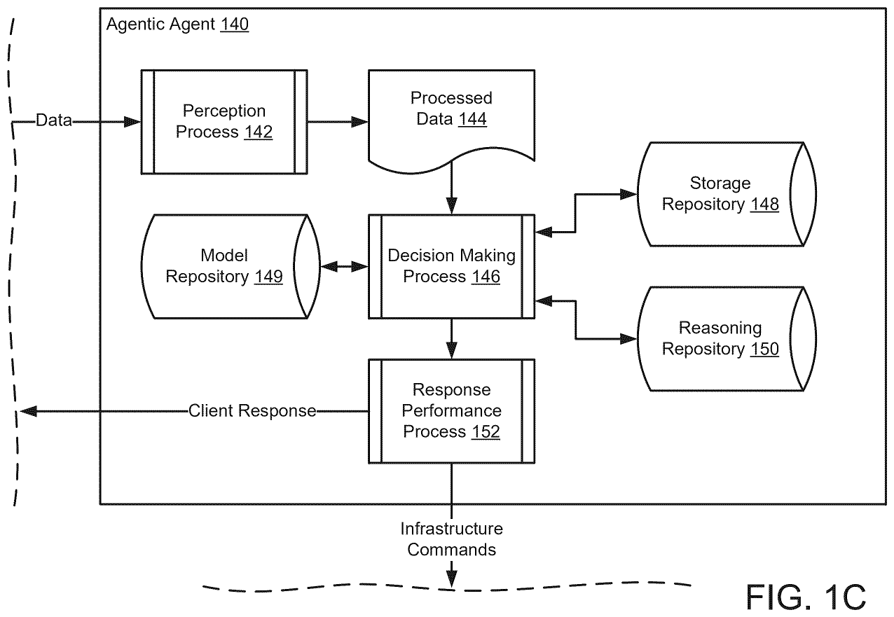

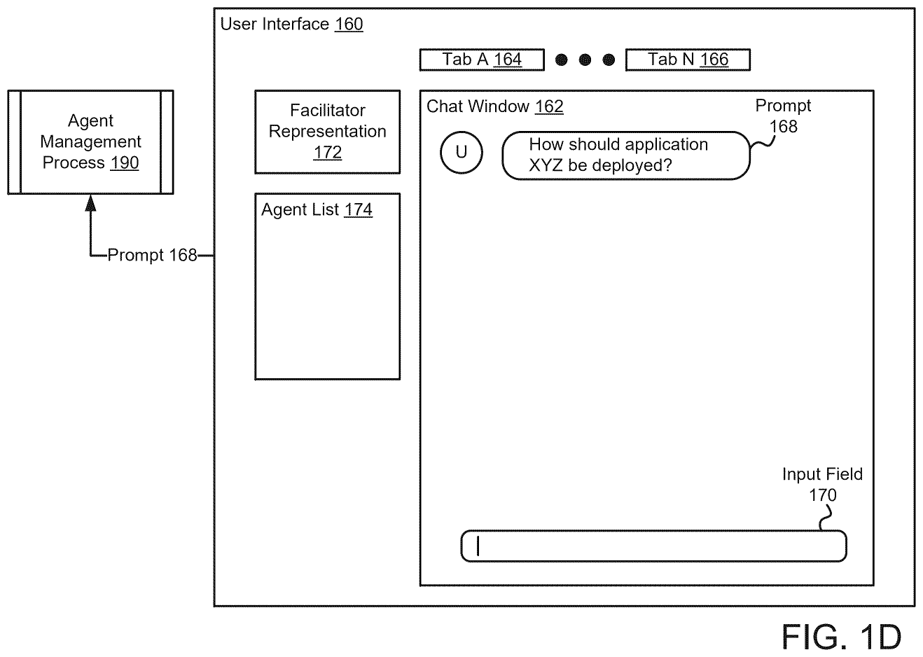

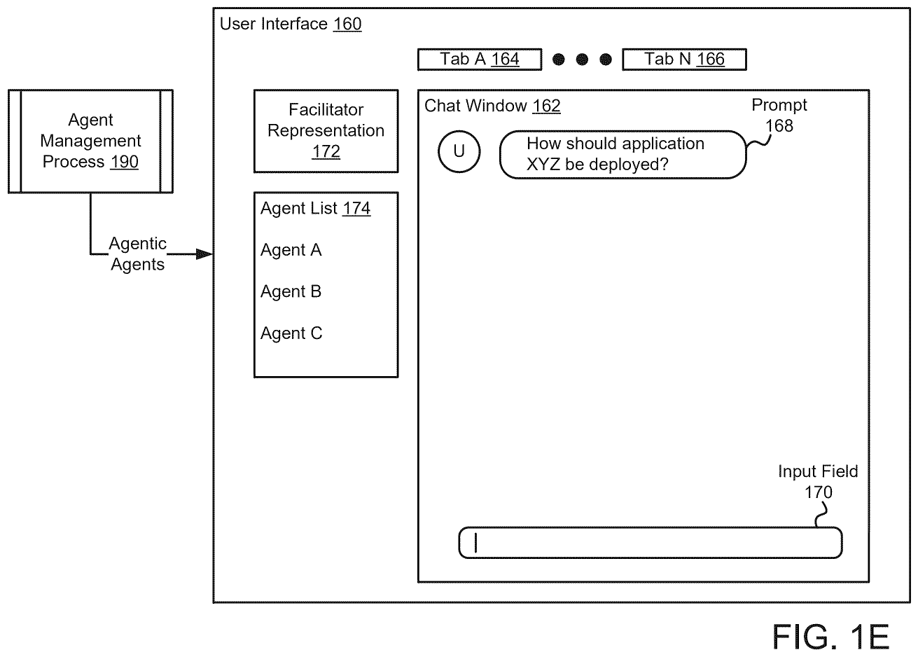

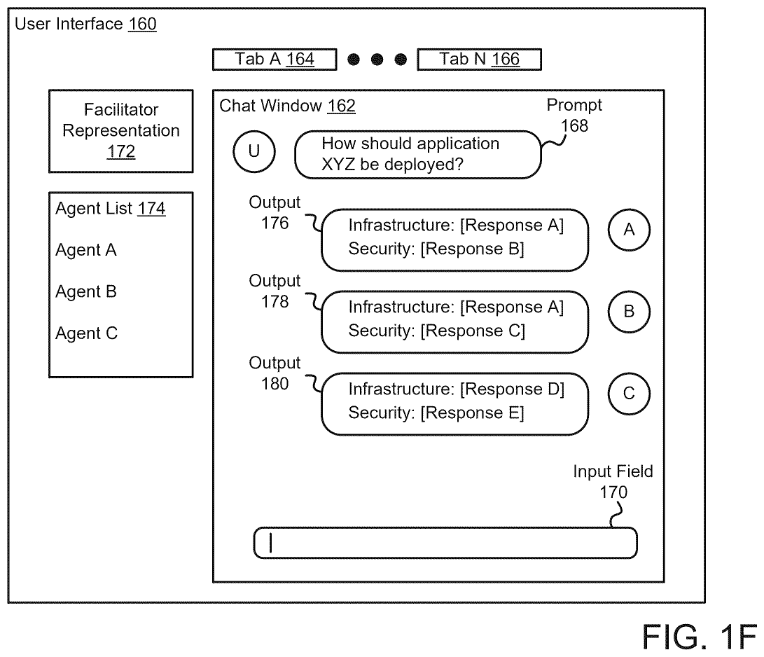

Turning to FIG. 1A, a block diagram of a system in accordance with an embodiment is shown. The system may provide any number and type of computer implemented services.

The computer implemented services may include, for example, database services, data processing services, communications, and/or other types of services. Any of the components of the system of FIG. 1A may provide all, or a portion, of the computer implemented services independently and/or in cooperation with other components of the system.

For the computer implemented services provided by the system of FIG. 1A to be deemed to be desirable by users (e.g., computer programs, persons, etc.) of the computer implemented services, the computer implemented services may need to meet various requirements (e.g., timeliness, accuracy, cost, etc.) and may need to be provided in certain manners (e.g., complete objectives). These requirements and manners may be indicated, for example, by users of the computer implemented services.

To ensure that the computer implemented services meet the requirements and manners of provisioning so that they are (or at least more likely to be) deemed to be desirable, the system of FIG. 1A may configure itself in a corresponding manner. For example, various pieces of software may be deployed, configurations of the software and/or hardware components may be set, various resources of the system may be reserved for contributing to the services, etc.

However, if the aforementioned configuration of the system of FIG. 1A is not successfully completed, then the computer implemented services may be more likely to be deemed to be undesirable. For example, if insufficient resources for providing the computer implemented services are reserved, then the provided computer implemented services may not meet timeliness (e.g., latency) goals. Other issues may impact the computer implemented services if the aforementioned configuration of the system of FIG. 1A is not successfully completed without departing from embodiments disclosed herein.

Further, a mismatch between an intent of the users regarding the computer implemented services and an understanding of the intent by the system of FIG. 1A may also reduce the likelihood of the computer implemented services being deemed to be desirable. For example, if a user only partially conveys an intent by making a tacit statement (e.g., a partial but incomplete statement of intent) regarding the computer implemented services to be provided, then the system may not successfully deploy a corresponding configuration necessary to provide the computer implemented services in a manner that meets that actual intent of the users.

Additionally, if a mismatch between an understanding of the users regarding future operation of the system of FIG. 1A and the actual likely future operation of the system may further reduce the likelihood of the computer implemented services being deemed to be desirable. For example, the users may have limited knowledge regarding how configurations of the system are likely to impact the provided computer implemented services. Consequently, even if informed of a configuration for the system (e.g., in scenarios where users or other persons establish the configuration), the users may incorrectly identify how the computer implemented services will be provided under that configuration (e.g., the users may expect the computer implemented services to meet different requirements and/or be provided in different manners). Accordingly, the actual computer implemented services may be less likely to meet the users' expectations thereby causing the actually provided computer implemented services to be less likely to be deemed to be desirable.

In general, embodiments disclosed herein relate to systems, methods, and devices for improving the likelihood of computer implemented services provided by systems meeting the expectations of requestors of the services (e.g., being deemed to be desirable). To improve the likelihood of the computer implemented services being deemed to be desirable, an agentic agent based framework may be used to manage the operation of the system. The agentic agent framework may facilitate (i) domain customization and deployment of domain customized agentic agents, (ii) chat based interactions between the domain customized agentic agents and users of the system, (iii) user intent identification and confirmation for the computer implemented services, (iv) cooperative analysis and decision making among the agentic agents, and/or (v) management of infrastructure by the domain customized agentic agents.

By doing so, embodiments disclosed herein may improve the likelihood of computer implemented services provided by a system being deemed desirable by the users for which the services are provided. Thus, embodiments disclosed herein may address, among others, the technical problems of (i) misinterpretation of requests and/or intent in distributed system, (ii) limited technical knowledge of users of the system that may preclude (or limit the ability of) the users from making configuration decisions that are likely to effectuate their intent, and (iii) system configuration drift that may preclude (or limit the ability of) the system to provide desirable computer implemented services.

To provide the above noted functionality, the system may include any number of client devices 100, managed infrastructure 102, management system 104, and communication system 106. Each of these components is discussed below.

Client devices 100 may be used by users (e.g., employees of a business, administrators, computer programs hosted by client devices 100, etc.) to manage and/or obtain computer implemented services provided by/from managed infrastructure 102. To do so, client devices 100 may host interfaces usable to communicate with managed infrastructure 102 and/or management system 104. For example, the interfaces may include chat interfaces through which chat sessions managed by management system 104 may be reached by the users. Client devices may include any number of such devices (e.g., 111, 112) used by any number of users.

Managed infrastructure 102 may provide computer implemented services. To provide the computer implemented services, managed infrastructure 102 may host automation frameworks usable to deploy software, manage configurations of software/hardware components, and/or otherwise modify the operation of various portions of managed infrastructure 102. All, or a portion, of the functionality of the automation frameworks may be usable by agentic agents managed by management system 104.

The agentic agents may be tasked with (i) collecting information from managed infrastructure 102 (e.g., state information, telemetry, etc.), (ii) interacting with users via the chat sessions, (iii) inferring intents of the users regarding computer implemented services to be provided by managed infrastructure 102, and (iv) modifying the operation of managed infrastructure 102 over time to attempt to effectuate the inferred intents.

Because the chat sessions may be an incomplete description of the intent of the users, information obtained by the chat sessions from the users may be treated as tacit statements (e.g., partial statements that may not be a complete declaration of an intent, may be in conflict with other tacit statements, etc.). The tacit statements may be used to infer the intent of the user over time (e.g., which may update as additional tacit statements are obtained). The inferred intent of the users may then be used to identify a goal state for operation of managed infrastructure 102. Once identified, the goal state may be used to select actions to be performed to modify the operation of managed infrastructure 102 to align the actual state of managed infrastructure 102 with the goal state (e.g., over time).

As part of inferring of the intents of the users, information regarding the actual state of management infrastructure 102 may also be taken into account. Thus, changes in the actual state of managed infrastructure 102 (e.g., changes in hardware components, changes in deployed software, changes in configurations, changes in conditions impacting managed infrastructure 102, etc.) may also change the inferred intents of the users.

To identify the actions to be performed, a quantification process regarding the intent may be performed. For example, an objective function may be formed and used to evaluate the impact of performance of different actions to modify the state of managed infrastructure 102. In an example, the objective function may be formed using key performance indicators (e.g., service latency, resiliency to cyberthreats, cost of operation, etc.) from the inferred intents. These key performance indicators may be compared to actual key performance indicators of the distributed system to identify the degree (e.g., which may be quantified by the objective function) to which the intents of the users are being effectuated by managed infrastructure 102.

Over time, the agentic agents may select actions to perform on the basis of attempting to maximize the degree to which the tents of the users are being effectuated by the actual operation of managed infrastructure 102.

Management system 104 may manage the agentic agents in the system. To manage the agentic agents, management system 104 may (i) customize and deploy domain customized agentic agents to facilitate management of managed infrastructure 102 and (ii) manage chat sessions to facilitate interactions between users and the domain customized agentic agents to (a) infer intents of the users, (b) inform the users of likely impacts for different potential changes in configuration of managed infrastructure 102, and/or (c) otherwise facilitate management of managed infrastructure 102.

When providing their functionality, client devices 100, managed infrastructure 102, and/or management system 104 may perform all, or a portion, of the flows and/or methods shown in FIGS. 1B-3B.

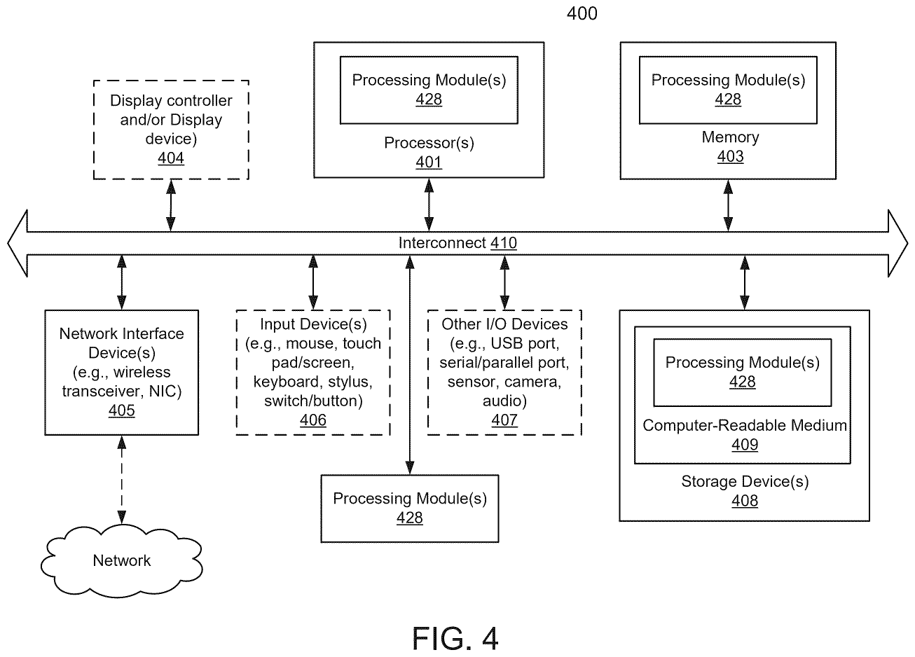

Any of the devices (and/or components thereof) included in the system shown in FIG. 1A may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with a communication system (e.g., 106). In an embodiment, this communication system includes one or more networks that facilitate communication between any number of components (e.g., including others not shown in FIG. 1A). The networks may include wired networks and/or wireless networks (e.g., and/or the Internet). The networks may operate in accordance with any number and types of communication protocols (e.g., such as the internet protocol).

While illustrated in FIG. 1A as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 1B-1F. These data flow diagrams may illustrate how data may be obtained and used within the system of FIG. 1A.

In the data flow diagrams, flows of data and processing of data are illustrated using different sets of shapes. In the context of these data flow diagrams, a first set of shapes (e.g., 144, 200, etc.) is used to represent data structures, a second set of shapes (e.g., 110, 112, etc.) is used to represent processes performed using and/or that generate data, and a third set of shapes (e.g., 114, 120, etc.) is used to represent large scale data structures such as databases.

Turning to FIG. 1B, a first data flow diagram in accordance with an embodiment is shown. The first data flow diagram may illustrate data used in and data processing performed in management of managed infrastructure.

To manage the managed infrastructure, a user may use a client device to perform client process 110. During client process 110, a management request may be sent to the management system. Based on the request, the management system may initiate performance of interface process 112.

During interface process 112, a chat session between the user and the management system may be initiated. The corresponding client process (e.g., 110) may obtain user input and direct it to the chat session managed by interface process 112. Refer to FIGS. 1D-1F for additional information regarding how the chat session may be performed.

During the chat session, information may be conveyed by the user regarding a goal, desire, requirements, and/or other characteristic of computer implemented services to be provided by managed infrastructure 102. The information may be used to identify (i) new agentic agents to be instantiated to assist in accomplishing the intent of the users, and/or (ii) new and/or existing agents to invite to chat session. The agents may be identified, for example, based on a prompt or other information provided by the users. Once identified, the agentic agents may participate in the corresponding chat session.

To instantiate new agentic agents, agent management process 116 may be performed. During agent management process 116, information regarding domains of expertise for an agent may be obtained. The identified domains may be used to discriminate relevant information from agent assets 120. Agent assets 120 may include any type and quantity of information usable to customize an agentic agent for a particular domain. Once obtained, the agentic agent may be customized for the domain (e.g., type of environment in which infrastructure that will be managed by the agent will reside, the particular goal or competency that the agent is desired to have, etc.) and then deployed. Refer to FIGS. 1C-1E for additional information regarding customization of agentic agents for domains.

The resulting agentic agents (e.g., agentic agents 118) may be customized for different operating environments such as, for example, a data center environment; a telecommunications computing environment; an edge computing environment; a cloud computing environment; a backup computing environment; an artificial intelligence environment; a co-located computing environment; and a storage computing environment. The agentic agents may also be customized for different domains of expertise of capabilities such as, for example, security; performance; data protection; resource management; health; and sustainability.

To perform the customization, agent assets 120 may include various types of information usable to customize the operation of, for example, generative artificial intelligence processes performed by, for example, large language models or other types of generative inferencing models used by the agentic agents. For example, agent assets 120 may include documentation for the infrastructure, software hosted by the infrastructure, testing performed for the infrastructure, support tickets for the infrastructure and corresponding resolution processes performed to address the issued indicated by the support tickets, telemetry data for operation of the infrastructure (and/or simulations of the infrastructure, such as digital twins), logs of operation of the infrastructure, etc.

The content of agent assets 120 may be pre-segmented or dynamically segmented with respect to the different domains (e.g., computing environment, competency/concern, etc.) to which the agentic agents may be customized. The content may be segmented with respect to relevancy for these different domains. The segmentation may be performed via any method. For example, a large language model may be used to process different portions of the content and classify it with respect to levels of relevancy, natural language processing and grading rubrics for relevancy may be used, subject matter experts may segment it, etc.

During the performance of interface process 112, information regarding the chat session may be stored in interaction history 114. The information may be used, for example, to document tacit statements made by the users. The tacit statements may be subsequently used to derive intents of the users, and select various management actions for performance to update the operation of managed infrastructure 102 over time. Thus, the operation of managed infrastructure 102 may be more likely to be aligned with the intents of the users and thereby provide computer implemented services that are more likely to be deemed to be desirable by the users.

Turning to FIG. 1C, a second data flow diagram in accordance with an embodiment is shown. The second data flow diagram may illustrate data used in and data processing performed in operation of agentic agents deployed in the system of FIG. 1A.

During operation, agentic agents may include various components that facilitate autonomy and decision making to manage various aspects of the operation of managed infrastructure. For example, an agentic agent may include tool layers that facilitate access and use of external entities to obtain information and drive external processes, reasoning layers to analyze the obtained information using, for example, large language models or other types of generative trained machine learning models, action layers to facilitate interactions between the agentic agents and external entities, and/or other layers.

To implement a tool layer, agentic agent 140 may perform perception process 142. During perception process 142, various types of data may be obtained from remote entities. The data may include, for example, information regarding the state of managed infrastructure, information from other agentic agents, communications of users and/or other entities participating in chat sessions, etc. Once obtained, the obtain data may be processed to obtain processed data 144.

To implement a reasoning layer, agentic agent 140 may perform decision making process 146. As part of decision making process 146, various reasoning algorithms from reasoning repository 150 may be performed, various portions of data may be stored in storage repository 148 for future use and existing information from storage repository 148 may be obtained, various models (e.g., large/small language models) from model repository 149 may be used, and/or other processes may be performed.

For example, a reasoning algorithm such as chain of thought from reasoning repository 150 may be performed. As part of the reasoning algorithm, various calls may be made to the language models from model repository 149 may be made to process various portions of processed data 144 (e.g., which may include text from a chat session, may be used as a prompt). The language models, in turn, may make various calls to data structures stored in storage repository 148 operating as pre-inference information retrieval sources for retrieval augmented generation (RAG). The resulting inferences from the language models may be used to drive the operation of the reasoning model to obtain various outcomes and store various portions of information in storage repository 148 for future use.

To implement an action layer, agentic agent 140 may perform response performance process 152. During response performance process 152, the outcomes obtained from the reasoning process may be used to invoke functionality of various other entities such as to, for example, send responses to chat sessions and modify the operation of the managed infrastructure. For example, when participating in a chat session, text from a user may be processed as a prompt by the agentic agent which may in turn generate a client response and/or initiate performance of an infrastructure command to modify the operation of the managed infrastructure. The infrastructure command may be processed by an automation framework of the managed system, and cause corresponding actions to be performed by the managed infrastructure. For example, the infrastructure command may be to change a configuration setting, remove/add/modify software, disable/enable various hardware components, etc.

Turning to FIG. 1D, a third data flow diagram in accordance with an embodiment is shown. The third data flow diagram may illustrate data used in and data processing performed in chat sessions used to manage the managed infrastructure.

When a client process reaches out to the management system, an agent management process (e.g., 190) may be performed. During the agent management process, a chat session may be initiated to facilitate interactions between users and agentic agents that manage portions of managed infrastructure.

It will be appreciated that the chat session may include various exchanges and storages of information temporally over time between various participants of the chat session. To facilitate understanding of the chat session, a user interface (e.g., 160) may be presented to a user participating in the chat session. User interface 160 may be a graphical user interface usable to represent how the user and other entities are participating in the chat session. User interface 160 may include, for example, tabs (e.g., 164-166), chat window 162, facilitator representation 172, and agent list 174. Each of these components is discussed below.

Tabs 164-166 may be graphical representations of different chat sessions that the user is participating in at any point in time. For example, during a duration of a chat session, a tab may exist. To page through the different chat session, the user may select corresponding ones of the tabs. When so selected, chat window 162, facilitator representation 172 and agent list 174 may be updated to reflect the chat session selected by the user.

Chat window 162 may be a graphical representation of contributions to a chat discussion made by the user and other entities. For example, chat window may include an input field (e.g., 170) through which the user may provide user input. The user input may be treated, for example, as prompt (e.g., 168) or other type of statement for processing.

For example, when a chat session is initially established, the user may enter text which may be processed as a prompt to attempt to identify agentic agents to participate in the chat session. In the context of a prompt such as “How should application XYZ be deployed”, the prompt may be processed using a large language model (or other type of analysis) to identify which agentic agents are likely to positively contribute to a discussion regarding the prompt (e.g., in the context of the managed infrastructure). The aforementioned prompt may result in the identification that new agentic agents should be instantiated due to the domains indicated by the prompt, and identification of existing agentic agents that are to participate in the discussion (e.g., on the basis of relevancy to the domains). As noted above, each customized agentic agent may be customized for a subset of domains (e.g., computing environment, competency, etc.).

Thus, prompt 168 may be processed by agent management process 190 which may in turn instantiate and/or connect various agentic agents to the chat session.

To inform the user of participants in the discussion, facilitator representation 172 may be graphical representation of a facilitator (e.g., an agentic agent, or other type of computerized entity) participating/guiding the discussion.

Likewise, to inform the user of the agentic agents, agent list 174 may include representations of the agentic agents that are participating in the discussion. In the example illustrated in FIG. 1D, no representations are included in agent list 174 because no agentic agents have joined the chat session.

Turning to FIG. 1E, a fourth data flow diagram in accordance with an embodiment is shown. The fourth data flow diagram may illustrate data used in and data processing performed in chat sessions used to manage the managed infrastructure.

Once agentic agents have joined the chat session, as shown in FIG. 1E, identities/representations of the agentic agents may be added to agent list 174. In this example, Agent A, Agent B, and Agent C are used. However, it will be appreciated that icons or other types of graphical elements may be used to convey to the user which agents are participating in the chat session.

Turning to FIG. 1F, a fifth data flow diagram in accordance with an embodiment is shown. The fifth data flow diagram may illustrate data used in and data processing performed in chat sessions used to manage the managed infrastructure.

Once agentic agents have joined the chat session, the agentic agents may independently and/or in cooperation participate in the chat session by, for example, generating output (e.g., 176-180) based on portions of the chat. The agentic agents may do so, for example, using their reasoning logic and language models. The output may be of any type and form. However, as discussed above, each of the agents may be customized for different domains. Consequently, the content of the responses generated by the respective agents may be different and aligned with the respective competency domains of the respective agents. As such, disagreements may occur in the different responses of the agents.

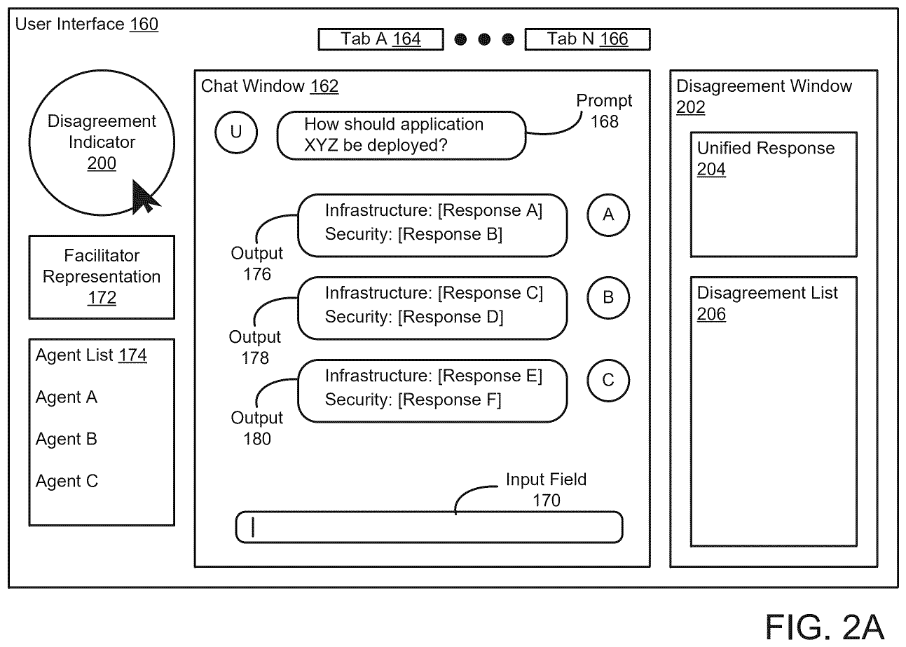

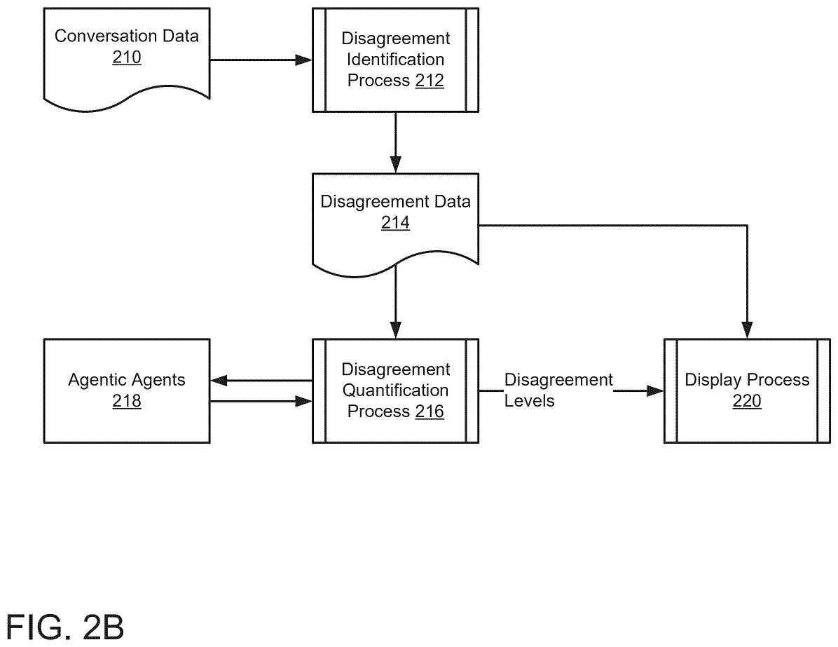

The chat session may then progress with the user adding addition information via input field 170 to the chat and the agentic agents participating in the chat generating corresponding responses. To improve a likelihood of obtaining feedback from the user indicating the intent of the user, disagreements between the agentic agents in the chat may be indicated to the user. By doing so, the disagreements may be attempted to be resolved, feedback (e.g., questions, relative agreement of the user, etc.) may be obtained from the user regarding the disagreements, and/or any other processes may occur to obtain understanding regarding the intent of the user. Refer to FIGS. 2A-2B for additional details regarding indicating disagreements between the agentic agents.

Overtime, the agentic agents may process the chat to generate proposed tacit statements regarding an intent of the user. These statements may be presented as an output to the user, and the user may confirm, modify, or deny acceptability of the tacit statements. To generate a proposed tacit statement, feedback from the user may be obtained.

When a tacit statement is confirmed, the confirmed tacit statement may be stored as part of the corpus of knowledge used to infer the intent of the user. The agentic agents may then act on the inferred intent of the user, as discussed above.

Turning to FIG. 2A, an example user interface is shown. As previously discussed in FIGS. 1D-1F, a user may participate in a chat session (e.g., conversation) using chat window 162 of user interface 160, a prompt may be issued by the user, agentic agents may join the chat session, outputs (e.g., 176-180) may be generated by the agentic agents, and/or any other processes may be performed.

For example, consider a scenario (shown in FIG. 2A) where the user issues a prompt “How should application XYZ be deployed?” to chat window 162. Agent A, agent B, and agent C may be added to the conversation. Agent A may be a representation of software architect. Agent B may be a representation of a development and operations engineer. Agent C may be a representation of a business manager. As such, each of the agentic agents in the conversation may be trained using different data sets for their respective domains and may subsequently present different viewpoints with respect to responses to the prompt.

Agent A may provide output 176 that may include, for example, text stating: “I would allocate 30% of our deployment to private cloud resources, focusing on workloads that require higher levels of data privacy, compliance, and integration with existing on-premises infrastructure. I would allocate 70% of our deployment to public cloud resources and utilize cloud microservices. I would implement a zero-trust architecture that enforces continuous monitoring to enforce strict identify verifications. This strategy would optimize resource allocation, enhance disaster recovery capabilities, and security”.

Agent B may provide output 178 that may include, for example, text stating: “I would allocate 30% of our deployment to private cloud resources, focusing on customer sensitive information to maintaining stricter control over our data environment. I would allocate 70% of our deployment to public cloud resources that have native integrations with our existing infrastructure to be implemented in our continuous integration and continuous deployment pipelines. I would implement a layered security approach that includes network security, application security, and data security measures. This strategy would maintain a secure and agile infrastructure.”

Agent C may provide output 180 that may include, for example, text stating: “I would allocate 60% of our deployment to private cloud resources, to capitalize on our existing private cloud resources. I would allocate 40% of our deployment to public cloud resources, for applications that require broader geographic reach. I would leverage built-in security tools and prioritize security measure based on risk levels and compliance requirements. This strategy would ensure compliance with regulations and take advantage of existing resources.”

However, a likelihood that user feedback may be obtained to understand an intent of the user may be negatively impacted if the user is unable to make decisions using the outputs of the agentic agents. For example, the user may be unable to make a decision regarding management of the infrastructure if the outputs include contrasting information (e.g., disagreements between the agentic agents), a volume of content of the outputs overwhelms a capacity of the user to process the information (e.g., multiple solutions to an issue), topics of the conversation are fragmented, and/or any other conditions may negatively impact an ability to receive feedback from the user to obtain an understanding of the intent of the user.

Thus, to improve a likelihood that feedback may be obtained from the user for understanding the intent of the user, information regarding a disagreement present in the conversation may be provided to the user. The disagreement may be identified by a facilitator (e.g., an agentic agent tasked with moderating the conversation) and indicated to the user using disagreement indicator 200. Refer to FIG. 2B for additional details regarding identifying and indicating the disagreement present in the conversation.

Disagreement indicator 200 may include, for example, a user interface element adapted to provide at least a portion of information regarding the disagreement. For example, disagreement indicator 200 may appear in an event a disagreement is identified, indicate a quantity of disagreements identified in the conversation, and/or provide any other information. User input may be obtained (e.g., clicking disagreement indicator 200) that indicates a request by the user to view the information regarding the disagreement.

The information may also be generated and/or provided, for example, via a disagreement view that may be displayed concurrently with the chat window 162. In FIG. 2A, disagreement window 202 is shown to illustrate an example of the disagreement view for providing the information regarding the disagreement to the user. Disagreement list 206 may include topics (e.g., issues) of the conversation, resolved issues, remaining disagreements, and/or any other information. A level of disagreement for each disagreement may also be identified and indicated (e.g., a quantified level of disagreement, color coding, etc.) to the user via disagreement list 206. Refer to FIG. 2B for additional details regarding identifying and displaying the disagreements and levels of disagreements for the disagreements.

For example, based on outputs 176-180, disagreement list 206 may include text stating: “Disagreement regarding infrastructure”. Disagreement list 206 may further include information that may contextualize at least one response of the disagreement. For example, the information may include text stating: “Agent C is proposing to deploy 40% of the software to public cloud resources to improve cost-effectiveness. However, agent A and agent B are proposing to deploy 70% of the software to public cloud to improve performance.”.

Each of the responses contributing to the disagreement may be presented to each of the other agents in the conversation by the facilitator and prompted to provide a new response regarding whether the response from the other agents is acceptable (e.g., in a second conversation between the facilitator and the other agentic agents). The second conversation may occur externally from chat window 162 (e.g., not directly viewable by the user, in a different tab, etc.). A level of the disagreement may be evaluated based on the new responses relevant to acceptability of the first responses and indicated in disagreement list 206 (e.g., using color coding, a score to indicate the level of disagreement, etc.).

Furthermore, unified response 204 may include a current version of tacit statement generated by the facilitator based on portions of the conversation (e.g., resolved issues, responses that are in agreement, etc.) and/or feedback from the user. For example, the user may use the information regarding the disagreement to provide feedback using input field 170 to indicate the intent of the user (e.g., preferences, relative agreement with one response involved in the disagreement, etc.). By doing so, an intent of the user may be inferred and/or understood with respect to managing the infrastructure.

Turning to FIG. 2B, a sixth data flow diagram in accordance with an embodiment is shown. The sixth data flow diagram may illustrate data used in and data processing performed in providing information regarding disagreements between agentic agents in a conversation.

To provide the information, disagreement identification process 212 may be performed. During disagreement identification process 212, topics may be identified using conversation data 210 and disagreements regarding one of the topics may be identified. Because the agentic agents may be customized for different domains, each agentic agent may have a different viewpoint regarding a topic (e.g., provide a different solution to an issue). Conversation data 210 may include at least a portion of the conversation in a chat session between the agentic agents and a user. For example, conversation data 210 may include a prompt issued by the user, responses by the agentic agents, metadata regarding screen position (e.g., relevant to a current topic being discussed in the conversation), and/or any other information.

To identify the disagreements, a facilitator may be prompted to identify topics of the conversation, topics that may be resolved (e.g., based on a level of consistency in responses of the agentic agents to a topic), and topics that may not be resolved (e.g., responses that do not meet the level of consistency). The disagreements in the responses of the agentic agents may be identified, for example, by using at least one large language model of the facilitator to analyze the responses relevant to a topic (e.g., via natural language processing). By doing so, disagreement data 214 may be obtained that may include, for example, responses identified as being in disagreement, a topic to which the responses pertain, information regarding the agentic agents involved in the disagreement, and/or any other information.

To identify a level of disagreement for a disagreement, disagreement quantification process 216 may be performed. During disagreement quantification process 216, acceptability results may be obtained from the agentic agents regarding responses involved in the disagreement (e.g., using disagreement data 214), and a level of disagreement for the disagreement may be evaluated based on the acceptability results. For example, the facilitator may provide a prompt using a response of disagreement data 214 to agentic agents 218. Agentic agents 218 may include a portion of the agentic agents in the chat session identified to be involved in the disagreement. The prompt may be provided using a prompt template that includes the response and a request for an agentic agent to provide a new response regarding whether the first response is acceptable with respect to the relevant topic (e.g., “Is this solution acceptable?).

The level of disagreement may subsequently be evaluated using the acceptability results from agentic agents 218. For example, based on the acceptability results, an average ratio of negative to positive acceptability results may be evaluated in terms of a probability distribution for each of a set of responses that are part of the disagreement. As such, a disagreement that has a higher probability ratio may indicate a higher level of disagreement than a second disagreement from the conversation that has a lower probability ratio. Furthermore, the level of disagreement may be compared to a threshold to determine whether the level of disagreement meets the threshold. For example, the disagreement may be displayed to the chat interface if the level of disagreement for the disagreement meets the threshold.

To provide information regarding the disagreement to the user, display process 220 may be performed. During display process 220, information regarding the disagreement may be provided to the user via the chat interface. For example, a disagreement indicator may be displayed to indicate that a disagreement has been identified in the conversation, responses regarding a topic may be indicated as disagreeing, the disagreement may be contextualized for the user (e.g., summarized, enhanced using supplemental information regarding the agentic agents, etc.), the level of the disagreement may be indicated (e.g., using color coding, displaying a score relevant to the level of disagreement, etc.), the disagreements may be ranked in an order based on the levels of disagreements, and/or information may be provided using any other processes.

Thus, via the data flow shown in FIG. 2B, a disagreement and a corresponding level of disagreement for the disagreement may be identified using responses from agentic agents in a conversation with a user. By doing so, the disagreement may be contextualized to improve a likelihood of obtaining user feedback based on the conversation for understanding an intent of the user.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

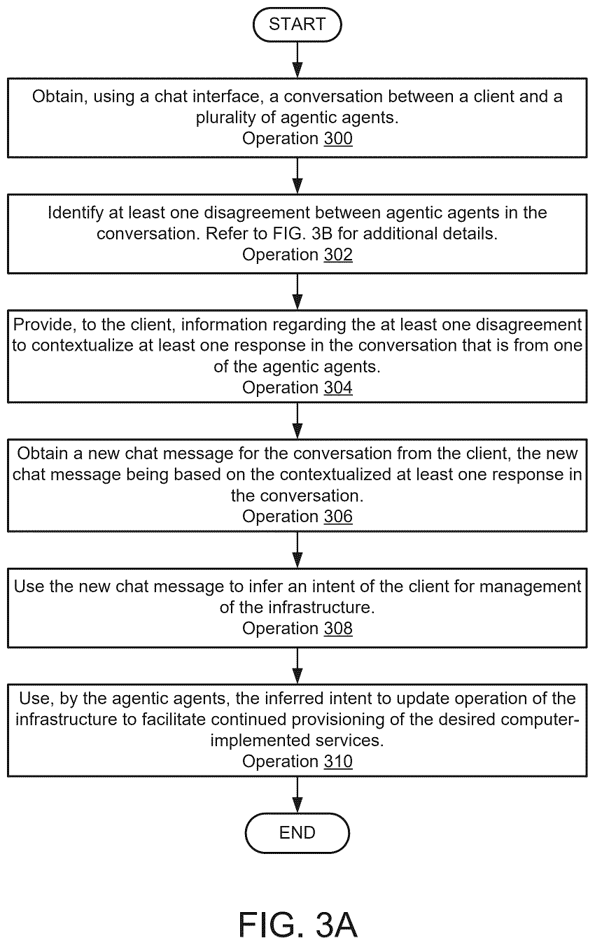

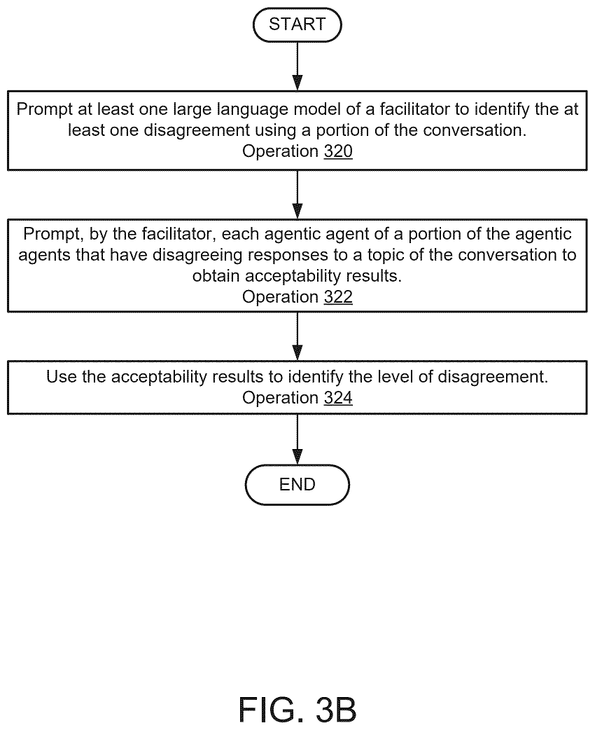

As discussed above, the components of the system shown in FIG. 1A may perform various methods to manage operation of infrastructure. FIGS. 3A-3B illustrate methods that may be performed by the components of the system of FIG. 1A. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing infrastructure using agentic agents in accordance with an embodiment is shown. The method may be performed by any of the components of FIG. 1A, and/or other entities without departing from embodiments disclosed herein.

At operation 300, a conversation between a client and plurality of agent agents may be obtained. The agentic agents may be adapted to manage the infrastructure on behalf of the client. The conversation may be obtained by: (i) initiating a conversation using a chat interface, (ii) receiving a prompt from the user using an input field to submit the prompt, (iii) identifying the agentic agents to participate in the conversation, (iv) generating responses to the prompts by each of the agentic agents, and/or via any other processes.

At operation 302, at least one disagreement between agentic agents in the conversation may be identified. The at least one disagreement may be identified by: (i) prompting at least one large language model of a facilitator to identify whether any disagreements are present in the conversation, (ii) identifying a level of disagreement for a disagreement, and/or via any other processes. Refer to FIG. 3B for additional details regarding identifying the at least one disagreement in the conversation.

At operation 304, information regarding the at least one disagreement may be provided to the client to contextualize at least one response in the conversation that is from one of the agentic agents. The information may be provided by: (i) displaying a user interface element indicating that a disagreement is present in the conversation, (ii) populating the user interface element with a number of disagreements, (iii) displaying a list of the disagreements that may be ordered based on levels of disagreements, (iv) providing supplemental information regarding the disagreement (e.g., responses, viewpoints of the agentic agents, etc.), and/or via any other processes.

At operation 306, a new chat message may be obtained for the conversation from the client. The new chat message may be obtained by: (i) receiving input from the user via an input field in the chat interface, (ii) generating a current version of a solution and receiving feedback from the user confirming or rejecting the current version of the solution, (iii) obtaining feedback from the user using other user interface elements (e.g., approval buttons, sliding range elements, etc.), and/or via any other processes.

At operation 308, the new chat message may be used to infer an intent of the client for management of the infrastructure. The new chat message may be used by: (i) generating a tacit statement based on the user feedback, (ii) aggregating the tacit statement with other tacit statements derived from the client (e.g., based on previous conversations), (iii) inferring the intent of the user based on the aggregated tacit statements (e.g., using a large language model), and/or via any other processes.

At operation 310, the inferred intent may be used by the agentic agents to update operation of the infrastructure. The inferred intent of the user may be used by: (i) obtaining information regarding a current state of operation of the infrastructure, (ii) identifying a management action based on a difference between the inferred intent of the user and the current operation of the infrastructure, (iii) performing the management action, and/or performing any other actions.

The method may end following operation 310.

Thus, via the method shown in FIG. 3A, embodiments disclosed herein may facilitate management of infrastructure by providing information regarding disagreements present in a conversation between a client and agentic agents. The information regarding the disagreements may be used to contextualize responses of the conversation to facilitate obtainment of client feedback that indicates an intent of the client with respect to operation of the infrastructure.

Turning to FIG. 3B, a second flow diagram illustrating a method for identifying disagreements in a conversation between a client and agentic agents in accordance with an embodiment is shown. The method may be performed by any of the components of FIG. 1A, and/or other entities without departing from embodiments disclosed herein.

At operation 320, at least one large language model of a facilitator may be prompted to identify the disagreement using a portion of the conversation. The facilitator may include an agentic agent tasked with moderating the conversation between the other agentic agents. As such, when responses are provided by the other agentic agents, the responses may be used as input to the large language model of the facilitator and prompted to identify whether any disagreements are present among the responses. A prompt template may be used that may include, for example, “What disagreements are present in these responses?”.

At operation 322, each agentic agent of a portion of the agentic agents that have disagreeing responses to a topic of the conversation may be prompted by the facilitator. For each response of the responses identified to be involved in the disagreement, an agentic agent may be prompted by the facilitator to provide a new response indicating whether the first response is acceptable by the agentic agent with respect to a topic. The agentic agents may be prompted by the facilitator by establishing a second conversation between the facilitator and the agentic agents (e.g., in a back-end chat session that may not be directly viewable by the client, in a chat session that may viewed by the user via a second tab of the chat interface, etc.).

At operation 324, the acceptability results may be used to identify the level of the disagreement. The acceptability results may be used to identify the level of the disagreement by: (i) evaluating an average probability ratio regarding whether a response is acceptable by other agentic agents, (ii) performing supervised learning using the acceptability results, (iii) comparing the acceptability results to evaluation metrics, and/or via any other processes.

The method may end following operation 324.

Thus, via the method shown in FIG. 3B, embodiments disclosed herein may identify levels of disagreement for a disagreement present in a conversation between a client and agentic agents. By doing so, responses of the agentic agents involved in the disagreement may be contextualized to provide information that may be more usable to the client compared to responses that are not contextualized with respect to the disagreement.

Embodiments disclosed herein may be implemented with one or more computing devices. Turning to FIG. 4, a block diagram illustrating an example of a data processing system (e.g., a computing device) in accordance with an embodiment is shown.

For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processors can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing infrastructure that provides desired computer implemented services, the method comprising:
obtaining, using a chat interface, a conversation between a client and agentic agents, the agentic agents being adapted to manage the infrastructure on behalf of the client;
identifying at least one disagreement between agentic agents in the conversation;
providing, to the client, information regarding the at least one disagreement to contextualize at least one response in the conversation that is from one of the agentic agents;
obtaining a new chat message for the conversation from the client, the new chat message being based on the contextualized at least one response in the conversation;
using the new chat message to infer an intent of the client for management of the infrastructure; and
using, by the agentic agents, the inferred intent to update operation of the infrastructure to facilitate continued provisioning of the desired computer implemented services.

2. The method of claim 1, wherein the at least one disagreement is regarding a topic of the conversation for which the agentic agents have different viewpoints.

3. The method of claim 1, wherein identifying the at least one disagreement comprises:
prompting at least one large language model of a facilitator to identify the at least one disagreement using at least a portion of the conversation, the at least a portion of the conversation comprising different responses of the agentic agents; and
identifying a level of disagreement for the at least one disagreement.

4. The method of claim 3, wherein identifying the level of disagreement comprises:
for each response of a plurality of responses that are involved in the at least one disagreement:
prompting, by the facilitator, a portion of the agentic agents that have disagreeing responses to a topic of the conversation to obtain acceptability results; and
using the acceptability results to identify the level of disagreement.

5. The method of claim 4, wherein prompting the portion of the agentic agents comprises:
prompting, by the facilitator, each agentic agent of the portion of the agentic agents using a first response of the plurality of responses to provide a new response regarding whether the first response is acceptable with respect to the topic.

6. The method of claim 3, wherein providing the information regarding the at least one disagreement comprises:
making a determination regarding whether the level of disagreement meets a threshold; and
in an instance of the determination where the level of disagreement meets the threshold:
displaying the information using the chat interface.

7. The method of claim 1, wherein providing the information regarding the at least one disagreement comprises:
providing a disagreement indicator using the chat interface that indicates that the at least one disagreement is present in the conversation.

8. The method of claim 7, further comprising:
obtaining user input from the client indicating a request to view the information regarding the at least one disagreement, the user input comprising selecting a button of the disagreement indicator.

9. The method of claim 1, wherein the contextualized at least one response comprises a unified response that is based on portions of the conversation upon which at least a portion of the agentic agents agree.

10. The method of claim 1, wherein the agentic agents are customized versions of trained agents, each version of the customized versions being trained using a different data set.

11. The method of claim 10, wherein the agentic agents are trained for different domains using different data sets, a viewpoint of an agentic agent of the agentic agents being based on a domain of the different domains for which the agentic agent is trained.

12. A non-transitory machine-readable medium having instructions stored therein, which when executed by a processor, cause operations for managing infrastructure that provides desired computer implemented services to be performed, the operations comprising:
obtaining, using a chat interface, a conversation between a client and agentic agents, the agentic agents being adapted to manage the infrastructure on behalf of the client;
identifying at least one disagreement between agentic agents in the conversation;
providing, to the client, information regarding the at least one disagreement to contextualize at least one response in the conversation that is from one of the agentic agents;
obtaining a new chat message for the conversation from the client, the new chat message being based on the contextualized at least one response in the conversation;
using the new chat message to infer an intent of the client for management of the infrastructure; and
using, by the agentic agents, the inferred intent to update operation of the infrastructure to facilitate continued provisioning of the desired computer implemented services.

13. The non-transitory machine-readable medium of claim 12, wherein the at least one disagreement is regarding a topic of the conversation for which the agentic agents have different viewpoints.

14. The non-transitory machine-readable medium of claim 12, wherein identifying the at least one disagreement comprises:
prompting at least one large language model of a facilitator to identify the at least one disagreement using at least a portion of the conversation, the at least a portion of the conversation comprising different responses of the agentic agents; and
identifying a level of disagreement for the at least one disagreement.

15. The non-transitory machine-readable medium of claim 14, wherein identifying the level of disagreement comprises:
for each response of a plurality of responses that are involved in the at least one disagreement:
prompting, by the facilitator, a portion of the agentic agents that have disagreeing responses to a topic of the conversation to obtain acceptability results; and
using the acceptability results to identify the level of disagreement.

16. The non-transitory machine-readable medium of claim 15, wherein prompting the portion of the agentic agents comprises:
prompting, by the facilitator, each agentic agent of the portion of the agentic agents using a first response of the plurality of responses to provide a new response regarding whether the first response is acceptable with respect to the topic.

17. A system, comprising:
a processor; and
a memory coupled to the processor to store instructions, which when executed by the processor, cause operation for managing infrastructure that provides desired computer implemented services to be performed, the operations comprising:
obtaining, using a chat interface, a conversation between a client and agentic agents, the agentic agents being adapted to manage the infrastructure on behalf of the client;
identifying at least one disagreement between agentic agents in the conversation;
providing, to the client, information regarding the at least one disagreement to contextualize at least one response in the conversation that is from one of the agentic agents;
obtaining a new chat message for the conversation from the client, the new chat message being based on the contextualized at least one response in the conversation;
using the new chat message to infer an intent of the client for management of the infrastructure; and
using, by the agentic agents, the inferred intent to update operation of the infrastructure to facilitate continued provisioning of the desired computer implemented services.

18. The system of claim 17, wherein the at least one disagreement is regarding a topic of the conversation for which the agentic agents have different viewpoints.

19. The system of claim 17, wherein identifying the at least one disagreement comprises:
prompting at least one large language model of a facilitator to identify the at least one disagreement using at least a portion of the conversation, the at least a portion of the conversation comprising different responses of the agentic agents; and
identifying a level of disagreement for the at least one disagreement.

20. The system of claim 19, wherein identifying the level of disagreement comprises:
for each response of a plurality of responses that are involved in the at least one disagreement:
prompting, by the facilitator, a portion of the agentic agents that have disagreeing responses to a topic of the conversation to obtain acceptability results; and
using the acceptability results to identify the level of disagreement.
